(19) United States
(12) Patent Application Publication
(10) Pub. No.: US 2011/0138836 A1
(43) Pub. Date: Jun. 16, 2011

(54) THREE FUNCTIONS IN A SINGLE WELL

(75) Inventors: KEVIN M. CHASE, SAINT JOSEPH, MI (US); TONY L. KOENIGSKNECHT, AUSTIN, TX (US); DOUGLAS D. LECLEAR, BENTON HARBOR, MI (US); KATE E. PRESNELL, KALAMAZOO, MI (US); JEROLD M. VISIN, BENTON HARBOR, MI (US)

(73) Assignee: WHIRLPOOL CORPORATION, BENTON HARBOR, MI (US)

(21) Appl. No.: 12/636,905

(22) Filed: Dec. 14, 2009

(51) Int. Cl. F25C 5/02; F25C 5/18; B23P 11/00

(52) U.S. Cl. 62/320; 62/344; 29/428

(57) ABSTRACT

An appliance including an ice manipulation reservoir capable of receiving ice having a base, wherein the base includes a first level and a second level, with the first level descending gradually to the second level. A first ice modification member is disposed inside the ice manipulation reservoir adjacent the first level of the base, and a second ice modification member is disposed inside the ice manipulation reservoir adjacent the second level of the base. A motor is operably connected with the ice manipulation reservoir and includes an output shaft. An impeller is connected with the output shaft proximate to the plurality of ice modification members, with the impeller being operable between a first directional rotation, and a second directional rotation.

### BACKGROUND OF THE INVENTION

Appliances are known for dispensing ice in various forms, such as ice cubes, crushed ice, and shaved ice. Some appliances that dispense ice in that fashion are domestic refrigeration appliances such as combined refrigerator/freezer appliances where the various forms of ice are delivered through the door of the appliance. While appliances generally do a good job of providing various forms of ice, there are limitations on being able to deliver three forms of ice from a single well. The provision of various forms of ice with multiple wells is limited to the spatial restraints of the appliance.

### SUMMARY OF THE INVENTION

One object of the present invention is to provide an appliance including an ice manipulation reservoir capable of receiving ice having a base, wherein the base includes a first level and a second level, with the first level descending gradually to the second level. A first ice modification member is disposed inside the ice manipulation reservoir adjacent the first level of the base, and a second ice modification member is disposed inside the ice manipulation reservoir adjacent the second level of the base. A motor is operably connected with the ice manipulation reservoir and includes an output shaft. An impeller is connected with the output shaft proximate to the plurality of ice modification members, with the impeller being operable between a first directional rotation, and a second directional rotation.

Another object of the present invention is to provide an ice modification mechanism. The mechanism includes an ice manipulation reservoir having a base, wherein the base includes a first level and a second level, the first level descending gradually to the second level. At least one ice modification component is disposed inside the ice manipulation reservoir. The at least one ice modification component is disposed substantially between the first level and the second level of the base. A motor is operably connected with the ice manipulation reservoir and includes an output shaft. An impeller is connected with the output shaft proximate to the at least one ice modification component, the impeller being operable between a first directional rotation, and a second directional rotation.

A further object of the present invention includes a method of making an ice modification mechanism. An ice manipulation reservoir is provided with a base. A first level and a second level are formed in the base, wherein the first level descends gradually to the second level. At least one ice modification component is installed laterally between the first level of the base and the second level of the base. A motor having an output shaft is connected to an impeller by the output shaft and the impeller is extended into the ice manipulation reservoir.

Additional objects, features, and advantages of the present invention will become more readily apparent from the following detailed description of the preferred embodiments when taken in conjunction with the drawings, wherein like reference numerals refer to corresponding parts in the several views.

### BRIEF DESCRIPTION OF DRAWINGS

FIG. 1. is a front elevational view of an appliance having an ice modification mechanism;

FIG. 2 is a front elevational view of the appliance having a freezer compartment and an above-freezing compartment;

FIG. 3A is a top perspective view of the ice modification mechanism;

FIG. 3B is a top perspective view of a motor located within an appliance;

FIG. 4 is a top perspective exploded view of the ice modification mechanism;

FIG. 5 is a top plan view of an ice manipulation reservoir;

FIG. 6 is a top plan view of the ice manipulation reservoir;

FIG. 7 is a top plan view of the ice manipulation reservoir containing a plurality of ice pieces;

FIG. 8 is a top plan view of the ice manipulation reservoir having a plurality of blades;

FIG. 9 is a top plan view of the ice manipulation reservoir with the impeller removed from the shaft;

FIG. 10 is a front elevational view of one embodiment of an impeller having a helical geometry;

FIG. 11 is a front elevational view of another embodiment of an impeller having a double helix geometry;

FIG. 12 is a front elevational view of another embodiment of an impeller having a shovel geometry;

FIG. 13 is a top plan view of the base of the ice manipulation reservoir;

FIG. 14A is a top plan view of the base of the ice manipulation reservoir illustrating the ice modification mechanism;

FIG. 14B is an elevational side view of the ice manipulation reservoir illustrating a spiral descend from a first level of the base to a second level of the base;

FIG. 15 is a front elevational view of the ice manipulation reservoir illustrating ice modification parameters;

FIG. 16A is a front elevational view of a trap door in an open position;

FIG. 16B is a front elevational view of a vertically oriented solenoid;

FIG. 16C is a front elevational view of a horizontally oriented solenoid;

FIG. 17A is a top perspective view of the base of the ice manipulation reservoir;

FIG. 17B is a side elevational view of a dispensing zone of the ice manipulation reservoir;

FIG. 18A is a top plan view of the base illustrating the trap door rotated about a hinge zero degrees;

FIG. 18B is a top plan view of the base illustrating the trap door rotated about a hinge ten degrees;

FIG. 18C is a top plan view of the base illustrating the trap door rotated about a hinge forty five degrees;

FIG. 19A is a side elevational view of the base illustrating the trap door rotated about a hinge zero degrees;

FIG. 19B is a side elevational view of the base illustrating the trap door rotated about a hinge ten degrees;

FIG. 19C is a side elevational view of the base illustrating the trap door rotated about a hinge forty five degrees; and

FIG. 20 is a side elevational view of a drop gap of the ice modification mechanism.

### DETAILED DESCRIPTION OF THE PREFERRED EMBODIMENTS

For purposes of description herein, the terms “upper,” “lower,” “right,” “left,” “rear,” “front,” “vertical,” “horizontal,” and derivatives thereof shall relate to the invention a refrigerator having a secondary cooling loop, and method thereof. However, it is to be understood that the invention may assume various alternative orientations, except where expressly specified to the contrary. It is also to be understood that the specific devices and processes illustrated in the attached drawings, and described in the following specification are simply exemplary embodiments of the inventive concepts defined in the appended claims. Hence, specific dimensions and other physical characteristics relating to the embodiments disclosed herein are not to be considered as limiting, unless the claims expressly state otherwise.

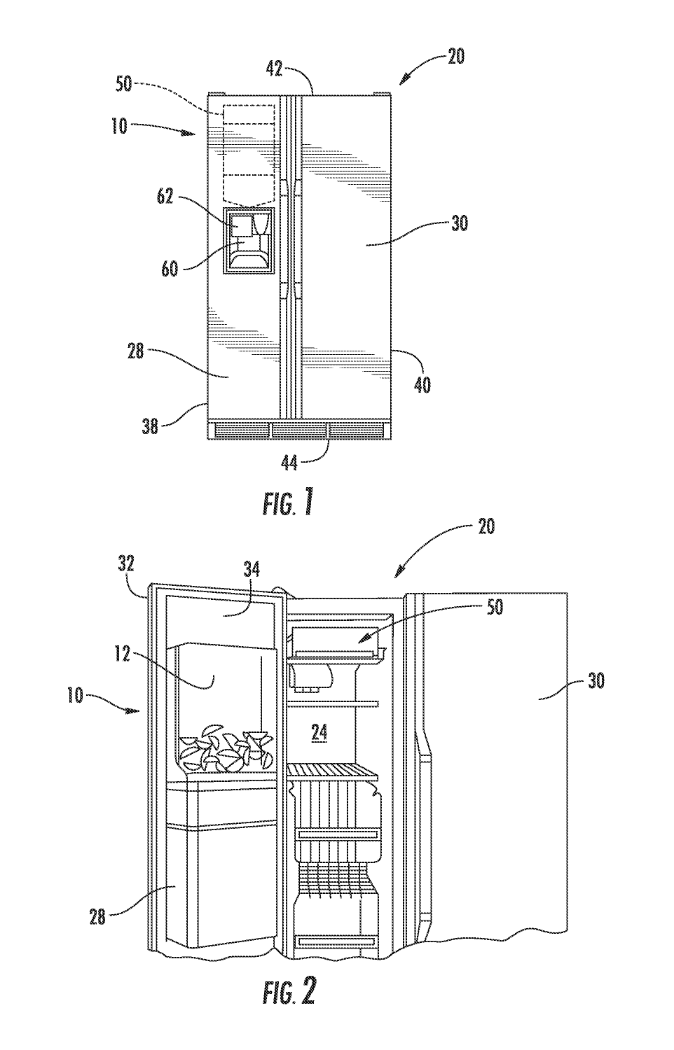

Referring to FIGS. 1 and 2, the reference number 10 generally designates an ice modification mechanism that includes an ice manipulation reservoir 12 having a base 14, wherein the base 14 includes a first level 100 and a second level 102, the first level 100 descending gradually to the second level 102. At least one ice modification component 70 is disposed inside the ice manipulation reservoir 12. The at least one ice modification component 72 is disposed substantially between the first level 100 and the second level 102 of the base 14. A motor 90 is operably connected with the ice manipulation reservoir 12 and includes an output shaft 92. An impeller 76 is connected with the output shaft 92 proximate to the at least one ice modification component 70, 72, the impeller 76 being operable between a first directional rotation A, and a second directional rotation B.

The present invention provides an ice modification mechanism 10 for delivering ice in each of the three selected forms, namely, cubed, crushed, and shaved. Generally, as used herein, ice cubes or bodies of ice having a three dimensional (3D) shape, wherein a length in any of the dimensions is typically not less than about two centimeters (2 cm). Shaved ice comprises bodies of ice having a three dimensional shape, in which at least one of the dimensions has a length of no greater than about five millimeters (5 mm). Crushed ice comprises bodies of ice having a three dimensional shape, in which at least one of the dimensions has a length greater than about five millimeters (5 mm), but less than about two centimeters (2 cm), and no dimension has a length greater than about five centimeters (5 cm).

This ice modification mechanism 10 can be arranged within an appliance 20 such as a domestic refrigerator having a refrigerated compartment, or other types of appliances, including freezers and ice makers. In the illustrated embodiment, as shown in FIGS. 1 and 2, a refrigerator 20 includes a cabinet 22 forming a freezer compartment 24 and an above-freezing refrigeration compartment 26. Both the freezer compartment 24 and the above-freezing refrigeration compartment 26 are provided with access openings 25. A freezer door 28 and an above-freezing door 30 are hingedly mounted to the cabinet 22 for closing the access openings 25. The doors 28, 30 of the appliance 20 have an exterior surface 32 and an interior surface 34 typically having a door liner 27. The refrigerator 20 also includes a rear wall section 36, a first side wall section 38, a second side wall section 40, a top 42, and a bottom 44. Although a side by side refrigerator is shown, it will be understood that the invention is not limited to such an arrangement.

An ice maker 50 is disposed within the freezer compartment 24. The ice maker 50 is an ice piece making apparatus which forms ice pieces, typically crescent shaped, although other shapes are conceivable. Such an ice maker 50 is taught in U.S. Pat. No. 7,278,275 entitled, “MECHANISM FOR DISPENSING SHAVED ICE FROM A REFRIGERATION APPLIANCE,” the disclosure of which is incorporated herein by reference. Generally, ice, in the form of cubes, which may have been made in the ice maker 50 disposed within the appliance 20 that the ice modification mechanism 10 is located within, is dispensed from the ice maker 50 to an ice manipulation reservoir 12. The ice may be transported to the ice manipulation reservoir 12 from the ice maker 50 by gravity or some other known delivering mechanism. The ice accumulates in the ice manipulation reservoir 12 until the user makes a demand for the ice. Known shut off mechanisms prevent ice harvesting or transfer of ice from the ice maker 50 to the ice manipulation reservoir 12 when the ice manipulation reservoir 12 is full of ice pieces. If ice harvesting is not appropriately controlled, the ice maker 50 may make an excessive quantity of ice and overflow the ice manipulation reservoir 12. In addition to limiting the quantity of ice produced, it may be desirable to prevent harvesting of ice when the freezer door 28 is open, based on the ice manipulation reservoir 12 being mounted to the door 28. If ice pieces are discharged when the door 28 is open, the ice pieces will fall onto the floor. To achieve these dual purposes, the appliance 20 includes components such as those described in U.S. Pat. No. 6,050,097 entitled, “ICE MAKING AND STORAGE SYSTEM FOR A REFRIGERATOR” the entire disclosure of which is incorporated herein by reference.

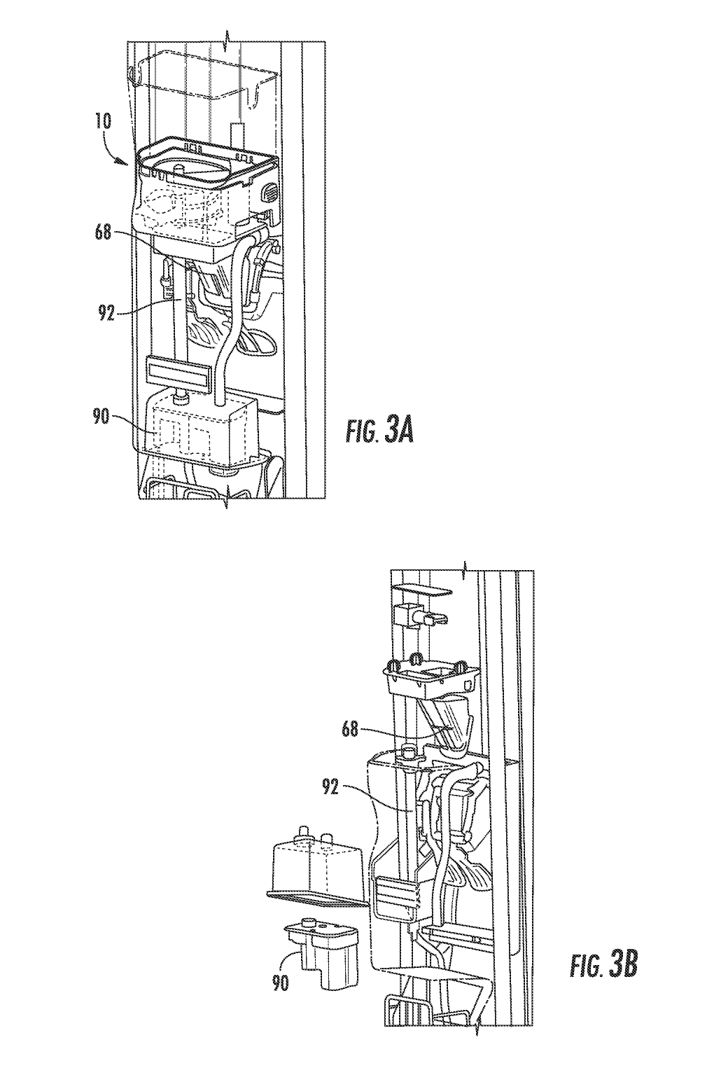

The ice manipulation reservoir 12 mounted to the freezer door 28 is typically provided below the ice maker 50 for receiving ice pieces therefrom in a substantially vertical transfer, however, a substantially horizontal transfer of ice pieces from the ice maker 50 to the ice manipulation reservoir 12 is conceivable (FIGS. 3A and 3B). The ice manipulation reservoir 12 includes a base 14 and at least one side wall 16. The side wall(s) 16 may form a cylindrical reservoir or another geometrically shaped reservoir. Once the ice manipulation reservoir 12 contains ice pieces, the ice manipulation reservoir 12 is capable of modifying the pieces from their original, typically cubed form, into other forms of ice, thereafter dispensing the ice through a dispensing zone 60 when prompted by the user. The user may prompt dispensing via a user interface 62 and/or a control mechanism 64 (not shown) arranged to effect dispensing ice from the ice manipulation reservoir 12 to the dispensing zone 60. The user interface 62 and the control mechanism 64 also allow the user to selectively control the form of preferred ice to be dispensed. Specifically, the user may select dispensing of ice cubes, crushed ice, or shaved ice, either singularly or in combination, as taught in U.S. patent application Ser. No. ______ (unofficial), entitled “MODULAR BUCKET AND DOOR ARCHITECTURE TO DELIVER THREE ICE FUNCTIONS,” filed on the same day herewith, the disclosure of which is hereby incorporated by reference in its entirety.

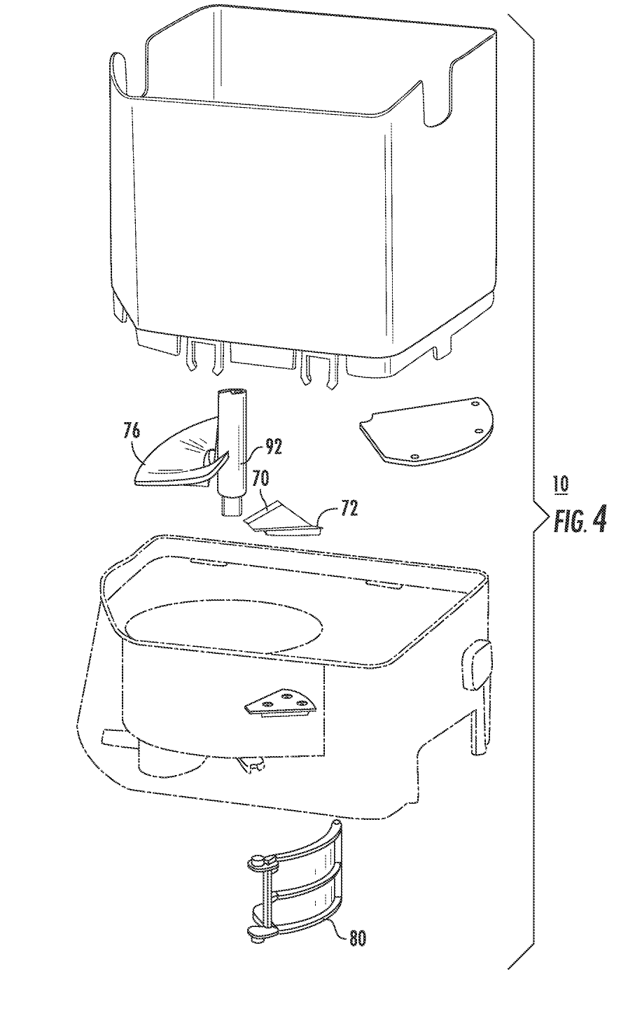

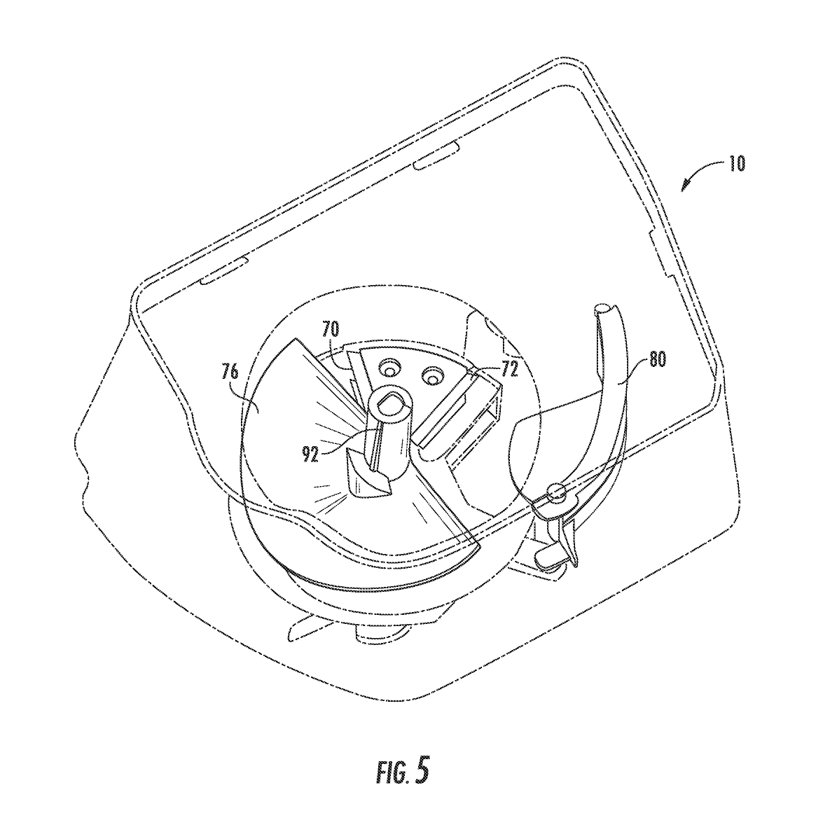

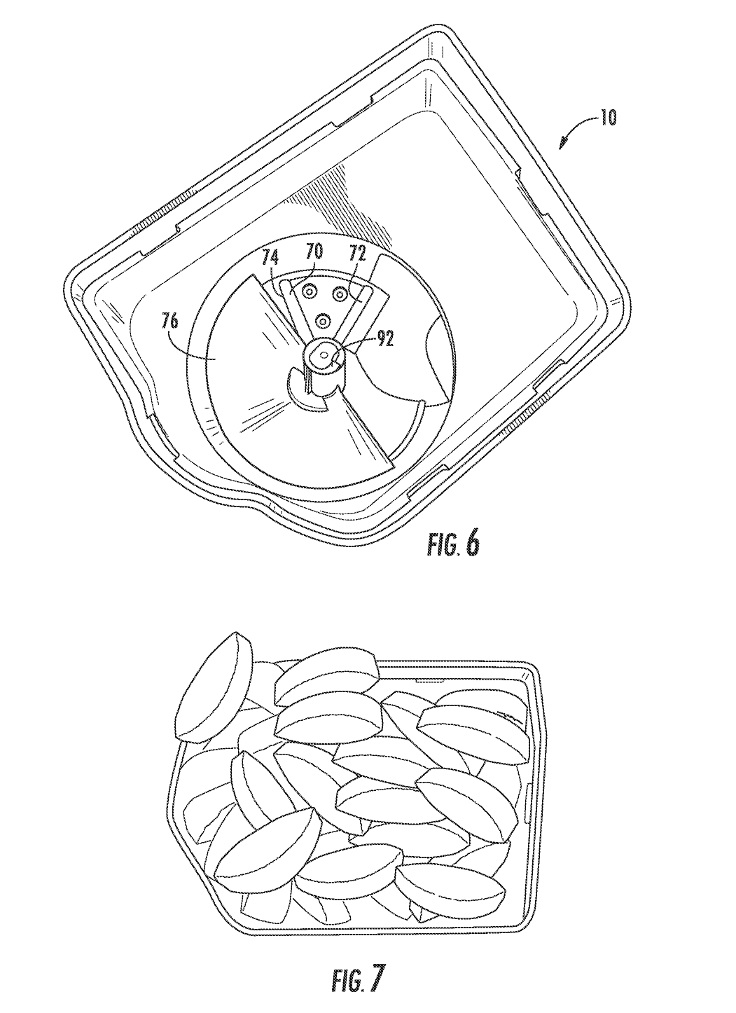

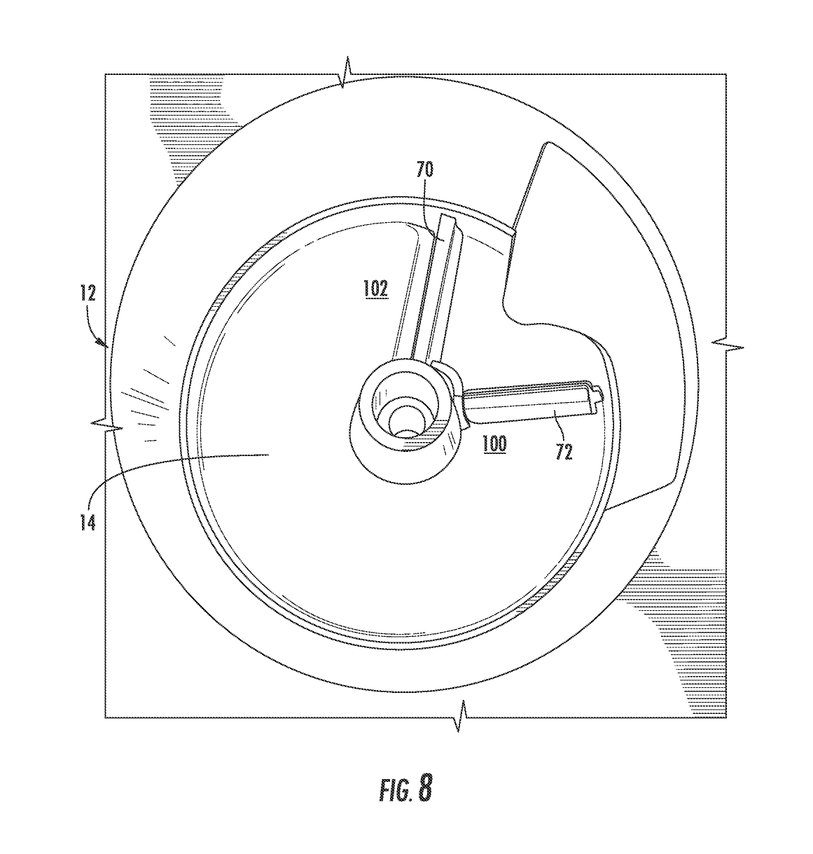

The capability to provide at least three forms of ice in a single well or ice manipulation reservoir 12 is illustrated in FIGS. 4-9. Positioned within the ice manipulation reservoir 12 is a first ice modification member or a crushing blade 70, as well as a second ice modification member or a shaving blade 72. The crushing blade 70 and the shaving blade 72 are located proximate the base 14 of the ice manipulation reservoir 12. The blades 70, 72 may be formed as one piece or may be completely separated. The illustrated examples show attachment of the blades 70, 72 to the base 14, but they may also be placed proximate, yet not attached, to the base 14, such that they are positioned to perform their crushing and shaving functions. The base 14 of the ice manipulation reservoir 12 also includes an integrally formed trap door 80 or provides an operable connection to the trap door 80. The blades 70, 72 are positioned such that a leading edge 74 of each blade 70, 72 is configured to modify ice upon interaction with the ice pieces. Disposed within the ice manipulation reservoir 12 is an impeller 76 that assists in facilitating the interaction of the ice pieces with the blades 70, 72. Specifically, the impeller 76 pushes the ice over the crushing or shaving blade 70, 72. The impeller 76 may have a variety of geometric configurations, including, but not limited to, a shovel type shape 77, a single helical shape 78, or a multiple helical shape 79 (FIGS. 10-12). The shovel type shape 77 is similar to a shovel blade. The shovel type shape 77 may include slight arcuate angles, but a substantially level blade may be employed. The substantially symmetrical shape allows for efficient ice manipulation in two directions. The helical embodiments function differently when the impeller 76 is rotated in opposite directions. This may be advantageous, depending upon the reservoir 12 geometry or function desired. The impeller 76 is driven by a motor 90 located within the appliance 20. The impeller 76 and the motor 90 may be connected directly or via an output shaft 92 that extends between the motor 90 and the impeller 76. This connection provides the impeller 76 the ability to rotate in two directions.

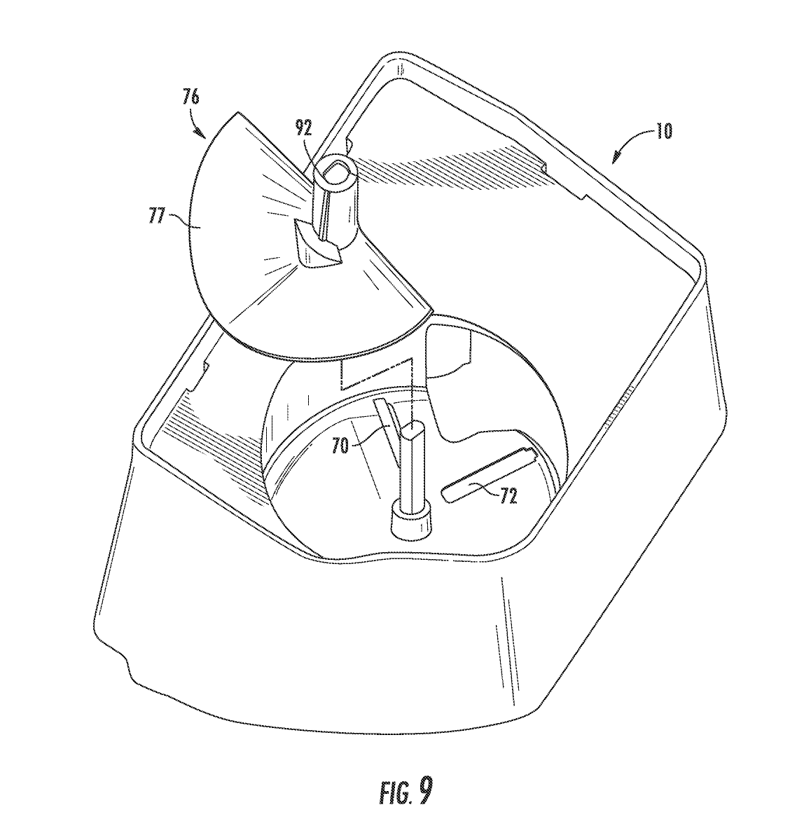

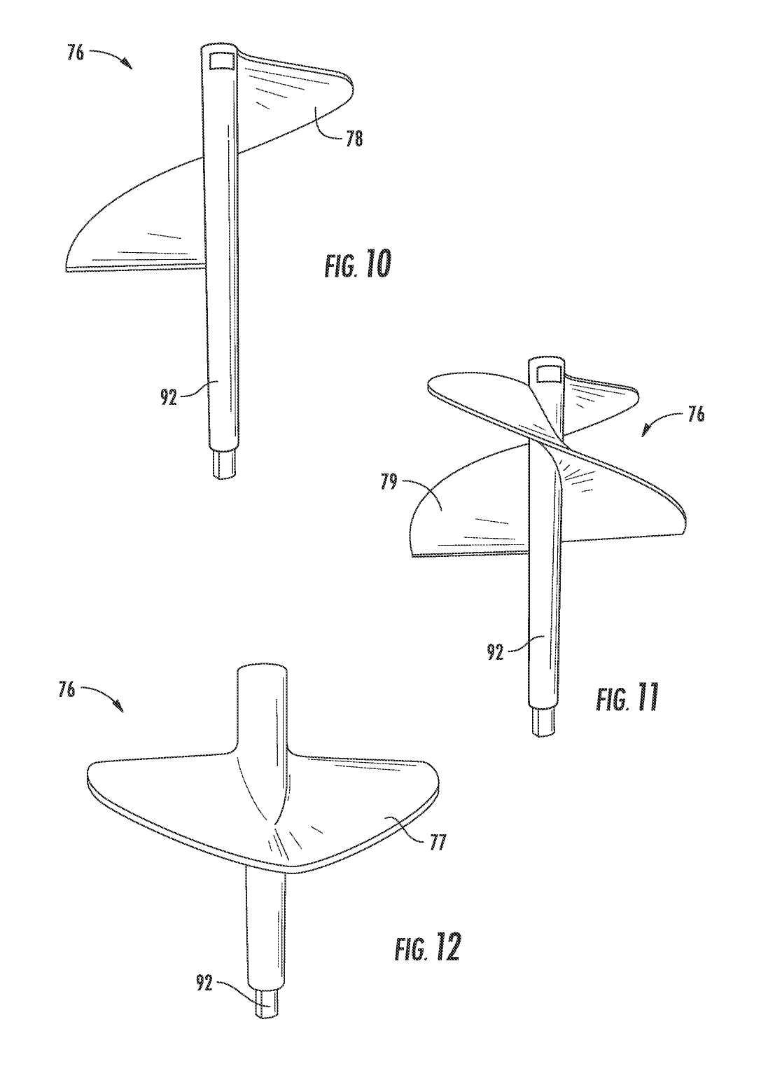

In a crushing mode, the motor 90 rotates the impeller 76 in a first direction A and the geometry of the impeller 76 pushes the ice pieces in the first direction A, while simultaneously applying a downward force. This motion initiates the interaction of the ice pieces with the leading edge 74 of the crushing blade 70, thereby modifying the ice pieces to crushed ice, as previously defined. In a shaving mode, the motor 90 turns the impeller 76 in a second direction B and the geometry of the impeller 76 pushes the ice pieces in the second direction B, while simultaneously applying a downward force (FIGS. 13 and 14). This motion initiates interaction of the ice pieces with the leading edge 74 of the shaving blade 72, thereby modifying the ice pieces to shaved ice, as previously defined.

While it is conceived that similar sized blades 70, 72 may be employed to crush and shave if positioned at different angles, it is envisioned that the crushing blade 70 has a larger volume than that of the shaving blade 72, based on the need to protrude deeper into ice pieces to effectively perform the crushing function. Conversely, the shaving blade 72 may only protrude slightly into the ice pieces, whereas too deep of a protrusion would result in an ice form not meeting the shaved ice parameter limitations as previously defined. Based on the need for a larger crushing blade 70, the base 14 of the ice manipulation reservoir 12 descends from a base first level 100 to a base second level 102, as opposed to having a horizontally level base. Placing the crushing and shaving blades 70, 72 on a uniform horizontal base would result in a top edge of the crushing blade 70 to be positioned at a height greater than the shaving blade 72. Such a configuration may prevent the impeller 76 from most efficiently performing the pushing function, as the crushing blade 70 may interfere with the motion of the impeller 76. Therefore, a non-level base 14 allows for the accommodation of a larger crushing blade 70 to be placed at a position of the base 14 with a deeper or lower level than that of the shaving blade 72 position level. Such a base 14 configuration is illustrated in FIGS. 13 and 14. The base 14 may descend gradually in a helical or spiral manner, as shown in FIG. 14A. In this arrangement, the shaving blade 72 is positioned proximate the first level 100, with the leading blade edge 74 facing in the direction of the base 14 descending direction. The base 14 descends gradually until reaching a lower most second level 102. The crushing blade 70 is positioned proximate the second level 102, with the crushing blade 70 top edge positioned proximate the same height and/or plane of that of the shaving blade 72 top edge. Subsequent to shaving or crushing, the ice may be dispensed under the blade 70, 72, into the dispensing zone 60. As an alternative to a gradual descend, the reservoir base 14 may accommodate the crushing blade 70 by having at least one step down from the base first level 100 to the base second level 102.

The positioning and geometry of the blades 70, 72 are critical factors in the shaving and crushing system. The physics behind such a system is illustrated in FIG. 15. The blade height (I) determines the thickness of the crushed piece, such that the greater the blade height, the thicker the crushed piece. Testing has determined that shaved ice is effectively produced with a blade height (I) of approximately two millimeters (2 mm), while crushed ice is effectively produced with a blade height (I) of approximately seven to nine millimeters (7-9 mm). The drop gap (D) regulates the piece size. Such regulation is accomplished based on the fact that no piece larger than the drop gap (D) may be dispensed to the user. Shaved ice will typically have a drop gap (D) of approximately six millimeters (6 mm), when used in conjunction with the aforementioned two millimeter (2 mm) blade, while crushed ice may require a drop gap (D) of approximately fourteen to eighteen millimeters (14-18 mm). An impeller gap (H) defines the minimum ice height available to push the ice around the ice manipulation reservoir 12.

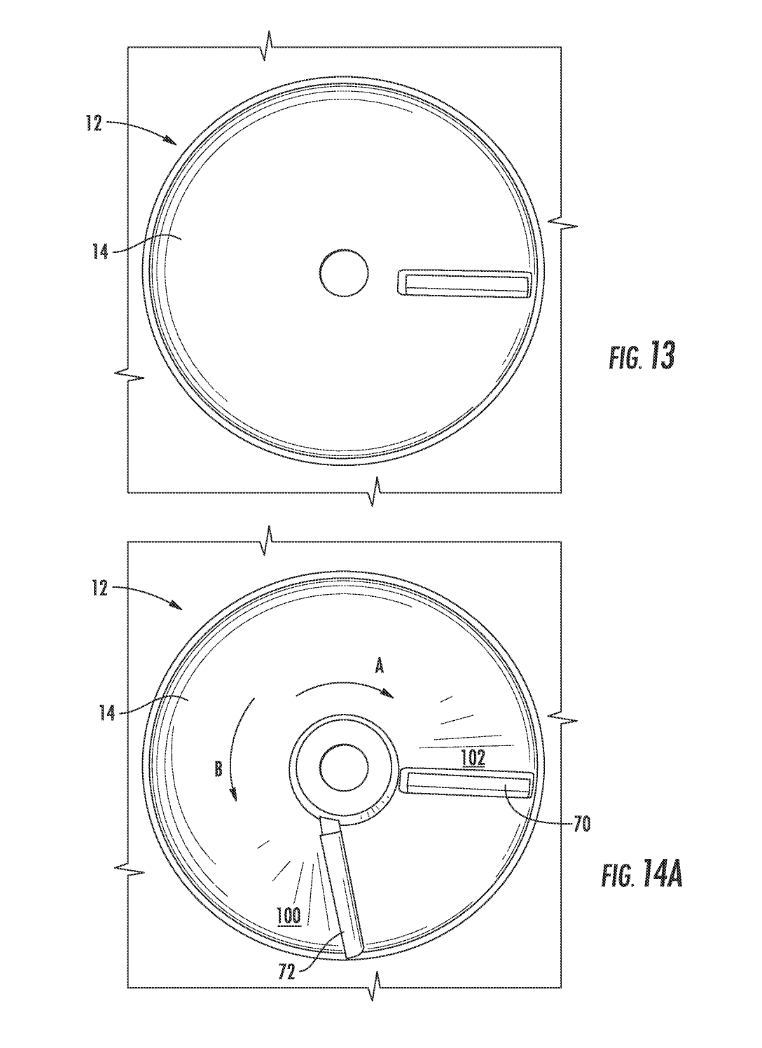

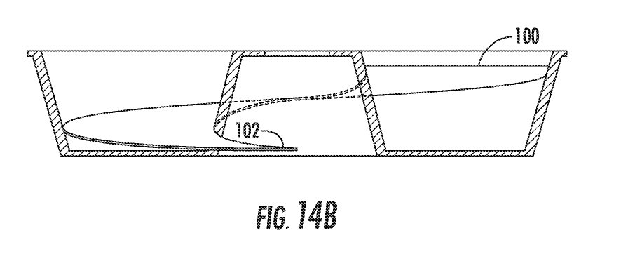

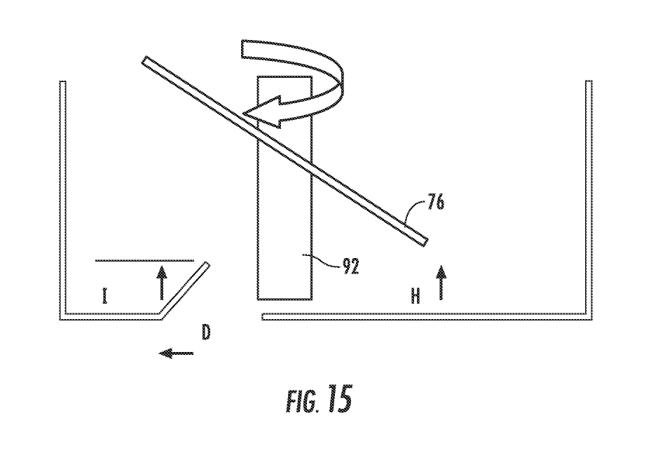

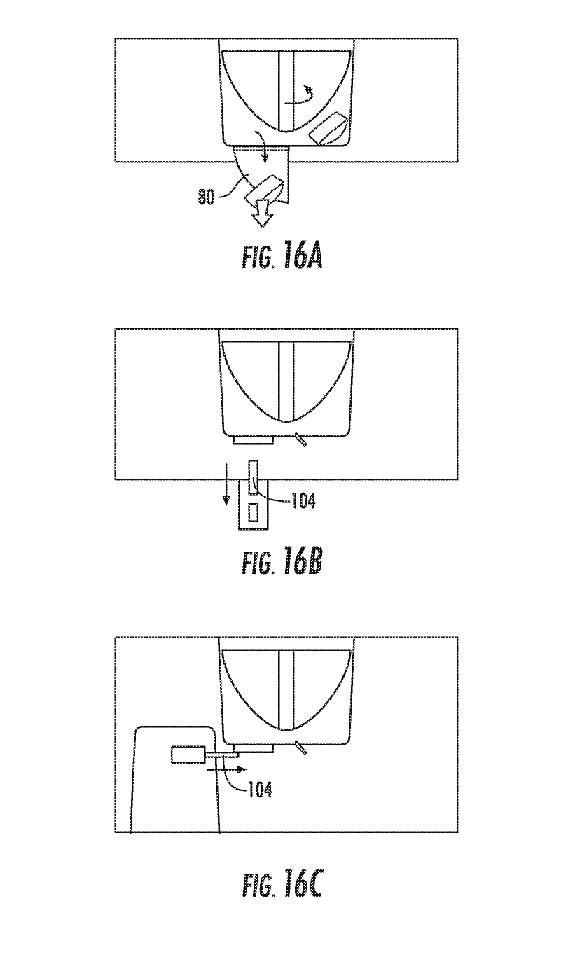

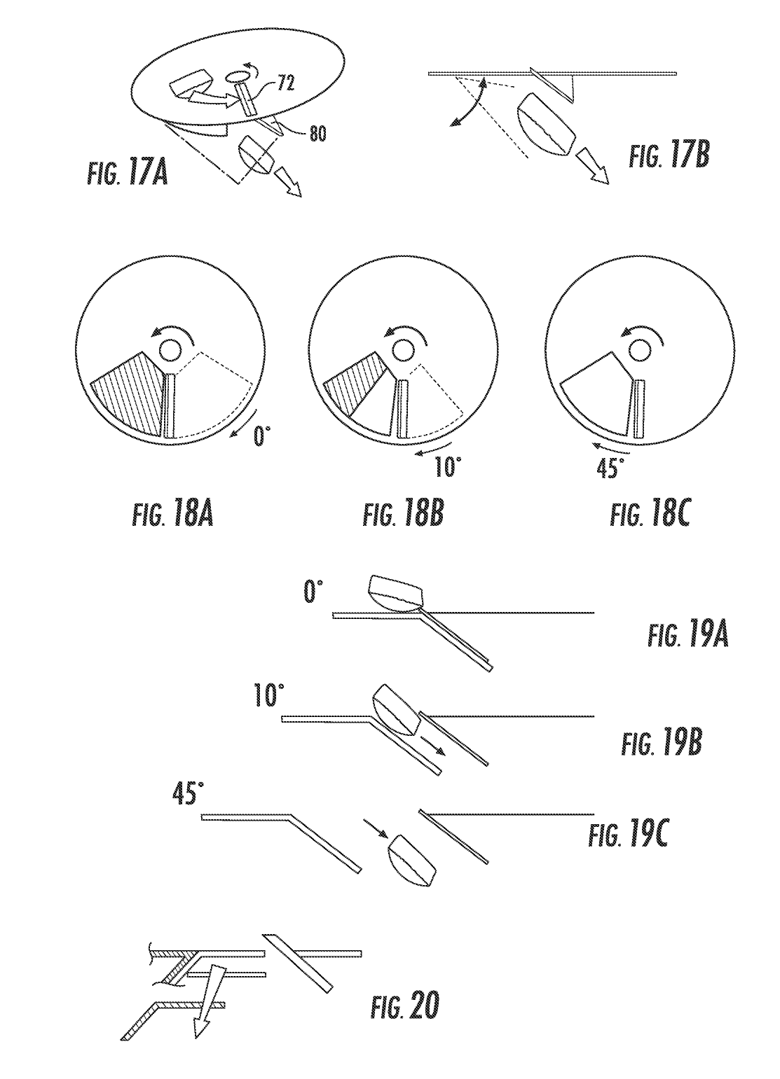

The base 14 also includes the trap door 80 that allows for the dispensing of ice. Typically, the trap door 80 will lead to the dispensing zone 60, such as a chute 68. As illustrated in FIGS. 16-20, the trap door 80 may be hingedly attached about a substantially vertical or a substantially horizontal axis. During the crushing or shaving mode, the trap door 80 remains in a closed position, whereas the trap door 80 is opened during dispensing of ice in a cubed form. A solenoid or some other mechanical or electromechanical device 104 may be used to open the trap door 80, as controlled by the user interface 62 and/or the control mechanism 64.

The ability of the motor 90 to drive the impeller 76 in at least two speeds, as well as in two directions A and B, provides the capability to produce at least three forms of ice in the single ice manipulation reservoir 12. The two directional capability, as briefly described earlier, forces an interaction with the ice pieces and the blades 70, 72. The direction of rotation determines whether the ice pieces are modified into crushed or shaved ice. This interaction only forces the modification of the ice pieces when the impeller 76 is driven by the motor 90 at a rate of speed X, which is greater than another speed Y. The lower speed Y pushes the ice around the ice manipulation reservoir 12 at a lower speed Y, thereby avoiding shaving or crushing. In an instance where the user desires cubed ice, the trap door 80 will open and the ice pieces are rotated at the lower speed Y. During this motion, ice cubes are dispensed to the user. When the impeller 76 is rotated at the higher speed X, the ice pieces are modified into shaved or crushed ice and dispensed to the user via an appropriate drop gap (D), the dimensions of which were previously defined.

The present invention further provides a method of making the ice modification mechanism 10. During manufacture, the method involves providing the ice manipulation reservoir 12 and forming a first level 100 and a second level 102 in the base 14, the dimensions of which are dependent on the blade sizes 70, 72 that must be accommodated. Subsequent to forming a geometrically appropriate ice manipulation reservoir 12, at least one blade 70, 72 is installed proximate the base 14. Within the appliance 20, a motor 90 having the ability to drive an impeller 76 is installed. The impeller 76 may be directly connected to the motor 90 or operably connected via one or more output shafts. Appropriate positioning of the impeller 76 in the ice manipulation reservoir 12 provides the ability to manipulate the ice pieces, as desired.

Advantageously, the present invention provides the ability to dispense three forms of ice to a user from a single source. This ability improves on issues of spatial restraints within appliances.

It is to be understood that variations and modifications can be made on the aforementioned structure without departing from the concepts of the present invention, and further it is to be understood that such concepts are intended to be covered by the following claims unless these claims by their language expressly state otherwise.

The invention claimed is:

1. An appliance comprising:
an ice manipulation reservoir capable of receiving ice having a base, wherein the base includes a first level and a second level, the first level descending gradually to the second level;
a first ice modification member disposed inside the ice manipulation reservoir adjacent the first level of the base, and a second ice modification member disposed inside the ice manipulation reservoir adjacent the second level of the base;
a motor operably connected with the ice manipulation reservoir and including an output shaft; and
an impeller connected with the output shaft proximate to the plurality of ice modification members, the impeller being operable between a first directional rotation, and a second directional rotation.

2. The appliance of claim 1, wherein the impeller comprises a shovel type shape.

3. The appliance of claim 1, wherein the impeller comprises a single helical blade.

4. The appliance of claim 1, wherein the impeller comprises a plurality of helical blades.

5. The appliance of claim 1, wherein the first ice modification member is an ice crushing blade, and wherein the second ice modification member is an ice shaving blade.

6. The appliance of claim 1, the appliance further comprising a door having an interior surface and an exterior surface, wherein the ice manipulation reservoir is mounted to the interior surface of the door.

7. The appliance of claim 6, wherein the ice is dispensed to a user through the door.

8. The appliance of claim 1, the appliance further comprising a control mechanism arranged to allow a user to actuate the dispensing of ice in the form selected from the group consisting of crushed, shaved, or cubed.

9. An ice modification mechanism comprising:
an ice manipulation reservoir having a base, wherein the base includes a first level and a second level, the first level descending gradually to the second level;
at least one ice modification component disposed inside the ice manipulation reservoir, wherein the at least one ice modification component is disposed substantially between the first level and the second level of the base;
a motor operably connected with the ice manipulation reservoir and including an output shaft; and
an impeller connected with the output shaft proximate to the at least one ice modification component, the impeller being operable between a first directional rotation, and a second directional rotation.

10. The mechanism of claim 9, wherein the impeller comprises a shovel type shape.

11. The mechanism of claim 9, wherein the impeller comprises a single helical blade.

12. The mechanism of claim 9, wherein the impeller comprises a plurality of helical blades.

13. The mechanism of claim 9, wherein the first ice modification member is an ice crushing blade, and wherein the second ice modification member is an ice shaving blade.

14. The mechanism of claim 9, wherein the mechanism is generally disposed within a housing having a door, wherein the door includes an interior surface and an exterior surface, wherein the mechanism is mounted to the interior surface of the door.

15. The mechanism of claim 14, wherein the ice is dispensed to a user through the door.

16. The mechanism of claim 9, the mechanism further comprising a control mechanism arranged to allow a user to actuate the dispensing of ice in the form selected from the group consisting of crushed, shaved, or cubed.

17. A method of making an ice modification mechanism comprising:
providing an ice manipulation reservoir with a base;
forming a first level and a second level in the base, wherein the first level descends gradually to the second level;
installing at least one ice modification component laterally between the first level of the base and the second level of the base;
providing a motor having an output shaft;
connecting an impeller to the output shaft; and
extending the impeller into the ice manipulation reservoir.

18. The method of claim 17, wherein the step of providing a motor further comprises:
providing a motor that is capable of rotating the impeller in two directions.

19. The method of claim 17, further comprising:
connecting the motor to a control mechanism actuated by a user interface.

20. The method of claim 17, further comprising:
providing an ice maker capable of introducing ice pieces to the ice manipulation reservoir.
